(19) United States
(12) Patent Application Publication
(10) Pub. No.: US 2002/0020701 A1
(43) Pub. Date: Feb. 21, 2002

(54) Eggcup for cooking eggs in a microwave oven

(76) Inventor: Guylaine Aubert, Buno-Bonnevaux (FR)

Correspondence Address: THOMAS CHRISTENBURY, Schnader Harrison Segal & Lewis LLP, Suite 3600, 1600 Market Street, Philadelphia, PA, 19103, US

(21) Appl. No.: 09/887,861

(22) Filed: Jun. 22, 2001

Related U.S. Application Data
(63) Continuation of application No. PCT/FR99/03320, filed on Dec. 30, 1999.

(30) Foreign Application Priority Data
Dec. 30, 1998 (FR) 98/16652

(51) Int. Cl. H05B 6/80

(52) U.S. Cl. 219/732; 219/762

(57) ABSTRACT

An eggcup for cooking an egg in a microwave oven including a container having an opening sized and shaped to house the egg or eggs to be cooked, and a lid fixable in an interdependent manner to the container, the container having a fastener substantially at the opening, the lid having an opening and a complementary fastener substantially at the opening, the fasteners being distributed on the circumference of the container and the lid, respective, at homologous positions, and wherein the container fastener faces outwardly and is positioned on a container rim of narrower thickness than the thickness of the container in a region of the opening, and wherein the lid fastener faces inwardly and is positioned on a rim of narrower thickness than the thickness of the container in a vicinity of the lid opening.

### RELATED APPLICATION

This is a continuation of International Application No. PCT/FR99/03320, with an international filing date of Dec. 30, 1999, which is based on French Patent Application No. 98/16652, filed Dec. 30, 1998.

### FIELD OF THE INVENTION

This invention relates to an eggcup for cooking eggs in microwave ovens.

### BACKGROUND

It is known that it is not possible to cook an egg in its shell in a microwave oven. Only a fresh egg can be cooked in this way without bursting. If the slightest cavity of air has formed, the sudden expansion of the air molecules causes bursting.

In the past, containers for cooking eggs in a microwave oven have already been proposed and marketed. These containers are generally formed of two parts: a container fitted with a base to house the egg or eggs to be cooked, and a lid which fits interdependently onto the container with or without locking.

In a particular embodiment the container is provided, in the vicinity of its opening, with fastening means and the lid, at its opening side, comprises complementary fastening means which face outwards. The container fastening means face inwards, the fastening means and the fastening clips being distributed on the circumference of the container and lid at homologous positions and only occupy a fraction of the respective circumference, less than one half of this circumference, to allow the insertion of the lid clips inside the container then, by a swivel movement, the interlocking of the clips underneath homologous fastening parts. The lid is provided with imprints in which to place the finger tips of one hand so that the lid can be placed in position and turned relative to the container, and with vents in the cavity hollows.

After placing the egg in position, the lid is fixed by inserting the clips in the fastening parts of the lower part or actual egg holder. Locking is made by a slight rotational movement in either direction.

After cooking, the eggcup is opened under the same conditions of simplicity. It suffices to turn the lid relative to the eggcup, first by overcoming the withholding force of the lid clips and fastening parts of the lower part of the eggcup.

The calibrated openings made in the finger hollows allow steam and hot air to escape to avoid overpressure inside the eggcup. This passageway between the inside and outside also facilitates the opening of the eggcup, which, since it is not under reduced pressure, may be easily opened once the lid has been unlocked relative to the container.

This eggcup, although it performs very well, has disadvantages which may make it tricky to use. During cooking, the vibrations due to the microwaves and the forces due to the pressure inside this eggcup, combined with the expansion of the container through the heat emitted by the egg, manage to dissociate and unlock the lid which is expelled and egg projections may occur at the same time. The second consequence of this defect is that the user is prompted to stop the cooking process regardless of the actual status of the egg.

Thus, it would be advantageous to remedy this defect by proposing a fastening system that is just as easy to apply by the user, but which is much more efficient in its use.

### SUMMARY OF THE INVENTION

This invention relates to an eggcup for cooking an egg in a microwave oven including a container having an opening sized and shaped to house the egg or eggs to be cooked and a lid fixable in an interdependent manner to the container, the container having a fastener substantially at the opening, the lid having an opening and a complementary fastener substantially at the opening, the fasteners being distributed on the circumference of the container and the lid, respectively, at homologous positions, and where the container fastener faces outwardly and is positioned on a container rim of narrower thickness than the thickness of the container in a region of the opening, and wherein the lid fastener faces inwardly and is positioned on a rim of narrower thickness than the thickness of the container in a vicinity of the lid opening.

### BRIEF DESCRIPTION OF THE DRAWINGS

The invention is described below in more detailed manner with reference to the drawings in which:

FIG. 1 is a sectional view of an eggcup of the invention showing the container and the lid in closed position.

FIG. 2 shows a horizontal sectional view of the device in close position.

FIG. 3 is a partial sectional view on an enlarged scale showing the eggcup in closed position.

FIGS. 4A, 4B and 4C are front view of a variant of the fastening clips of the container and lid, and the assembly of both clips.

FIG. 5 is an overhead view, on an enlarged scale, of a locking system on the container.

### DETAILED DESCRIPTION

It will be appreciated that the following description is intended to refer to specific embodiments of the invention selected for illustration in the drawings and is not intended to define or limit the invention, other than in the appended claims.

This invention concerns an eggcup for cooking eggs in a microwave oven, comprising a container to house the egg or eggs to be cooked and a lid which fits onto the container in interdependent manner, the container being provided, in the vicinity of its opening, with fastening means, and the lid comprising, in the vicinity of its opening, with complementary fastening means, the fastening means being distributed on the circumference of the container and lid at homologous positions. The container fastening means face outwards and are positioned on a rim having a narrower thickness than the thickness of the container in the vicinity of the container opening. The lid fastening means face inwards and are positioned on a rim having a thickness that is narrower than the thickness of the container in the vicinity of the lid opening.

Advantageously, the fastening means are formed of clips of complementary shape which only occupy a fraction of the respective circumference, less than about one half of this circumference, to allow insertion of the lid clips inside the container then, by a swivel movement, the locking of the clips under the homologous container fastening parts.

In one variant, the container clips are formed of a stop part and a bump allowing interlocking of the lid clips which pass over the bump and are locked in position by the stop part.

Preferably, the thickness of the eggcup is substantially uniform in its closed position, in the vicinity of the openings.

In one preferred embodiment, the eggcup is such that when it is closed, a cavity is left free at the base of the supporting rim of the container fastening means. The material used for the lid may retract upon heating and/or the material used for the container may soften under heating, this change in configuration reinforcing the locking.

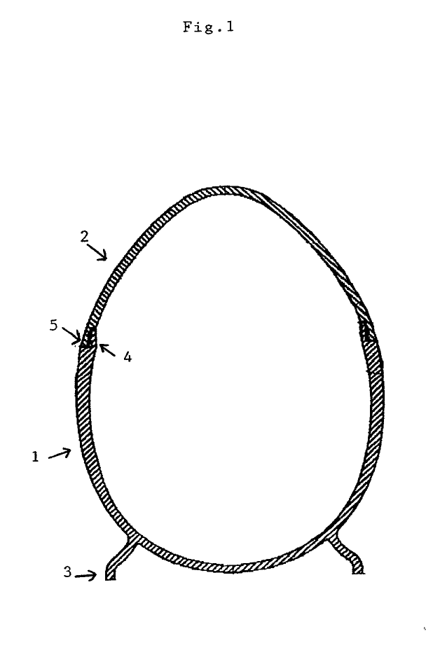

Turning now to the drawings in general and FIG. 1 in particular, the invention concerns an eggcup formed of two parts, a container 1 and a lid 2 fixed to the container.

Container 1 is in tumbler form provided with stabilization means 3 which may be in the shape of feet. Close to its upper edge, the container has a rim 4 of narrower thickness than the thickness of the container and positioned on the smallest circumference of the container. Rim 4 serves as a support for the fastening means, which here consist of ridges facing away from the container. Lid 2 is of ovoid shape. On its lower edge it has a rim 5 positioned on its largest circumference and acts as a support for the fastening means complementing those of the lid 1. These means face towards the inside of the lid.

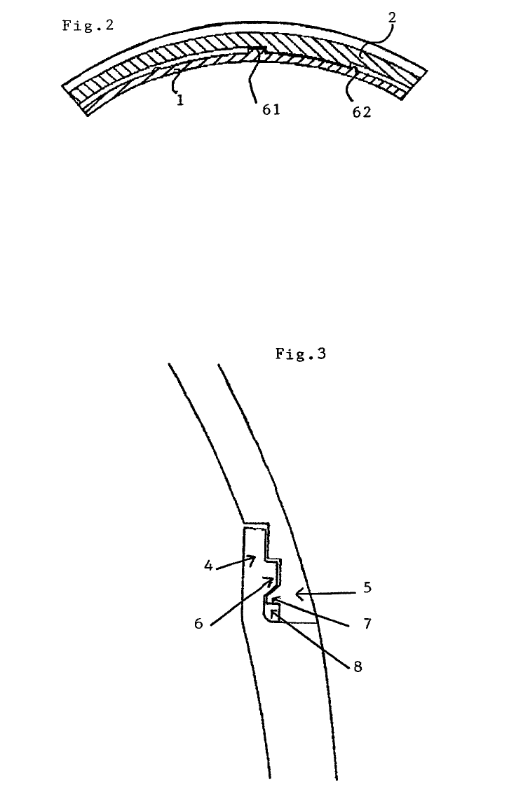

FIG. 3 is a partial sectional view on an enlarged scale showing the eggcup in closed position. On rims 4 and 5 fastening clips 6 and 7 can be seen. A cavity 8 is left empty in this arrangement. Cavity 8 is used to reinforce locking during cooking. Throughout cooking, the egg transmits part of its received heat to the container. This transmitted heat softens the material used for the container, which fills cavity 8 providing an additional locking point.

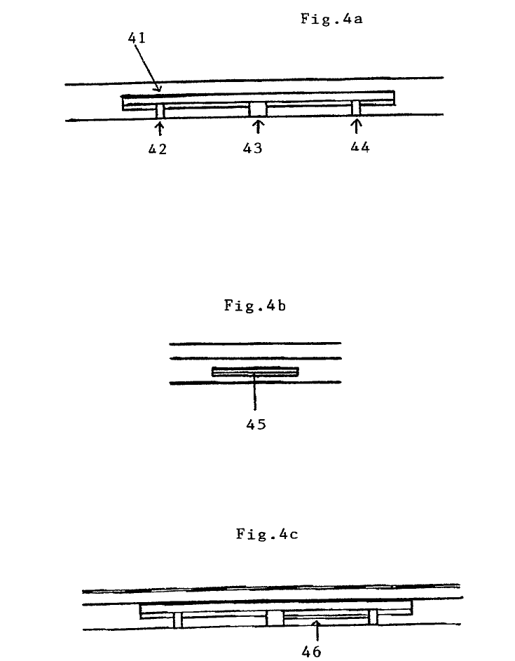

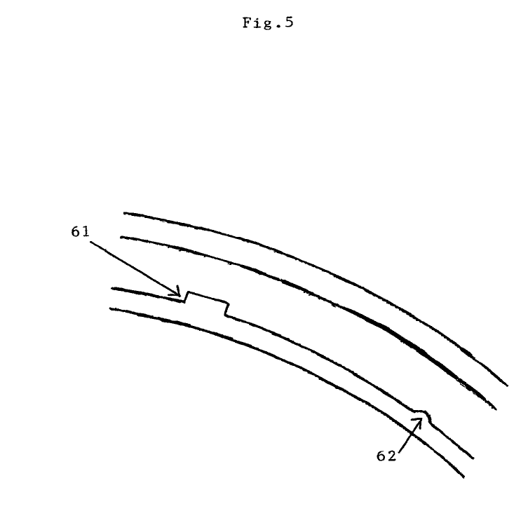

FIGS. 4A, 4B and 4C show variants of the fastening clip. FIG. 4A is a view of a clip arranged on the container and comprises a horizontal part 41 attached to the container at a minimum number of three regularly distributed points 42, 43, 44. The length of the complementary part 45 is substantially equal to the distance between two attachment points, such that in closed position (FIG. 4C), both parts are in fixed position. The height of complementary part 45 is less than the height of attachment points 42, 43, 44 to form a cavity 46 according to the invention. These fastening parts are preferably distributed in equiangular fashion on container 1 and lid 2.

FIG. 5 shows a specific locking system. The clips of container 1 are formed of a stop part 61 and a bump 62 allowing insertion of the lid clips which pass over the bump 62 and come to an end point with the stop part. FIG. 2 shows this device in closed position.

Lid 2 is hat-shaped so that, when placed on container 1, the assembly is of a smooth ovoid shape. Positioning of the lid is made as follows:

The lid is placed on the container such that the fastening means are not contacted. A rotational movement is then imparted to the lid on the container until the lid clips interlock with the container clips. This operation is made possible by the physical characteristics of the material used, which provides for slight deformation when the fastening means are being placed in position. Once interlocked, the fastening parts lock the lid in place. In a simpler variant, interlocking is achieved when the lid is placed on the container, with no rotation of the lid.

Opening is achieved by a reverse procedure under the same conditions of simplicity.

The eggcup of the invention such as described above, is preferably made by molding in a food-safe plastic material, polypropylene, for example. This plastic material may be chosen such that is softening on heating is controlled and enables the lid to be optimally fixed to the container.

What is claimed is:

1. An eggcup for cooking an egg in a microwave oven comprising:
a container having an opening sized and shaped to house the egg or eggs to be cooked; and
a lid fixable in an interdependent manner to the container, the container having a fastener substantially at the opening, the lid having an opening and a complementary fastener substantially at the opening, the fasteners being distributed on the circumference of the container and the lid, respective, at homologous positions, and wherein the container fastener faces outwardly and is positioned on a container rim of narrower thickness than the thickness of the container in a region of the opening, and wherein the lid fastener faces inwardly and is positioned on a rim of narrower thickness than the thickness of the container in a vicinity of the lid opening.

2. The eggcup according to claim 1, wherein the container and lid fasteners are clips of complementary shape which only occupy a fraction of the respective circumferences of the rims, to allow alignment of the lid clips with the container rim and by rotational movement, interlocking with the fastener clips.

3. The eggcup according to claim 2, wherein the container clips are formed of a stop part and a bump allowing insertion of the lid clips by passing over the bump and locking in place by the stop part.

4. The eggcup according to claim 1, wherein the eggcup has a thickness that is substantially uniform in a closed condition, in the vicinity of the respective openings.

5. The eggcup according to claim 1, wherein, when the eggcup is in a closed condition, a cavity is formed below the container fastener.

6. The eggcup according to claim 1, wherein the lid is formed from a material that retracts on heating.

7. The eggcup according to claim 1, wherein a material used for the container softens under heating, and a resulting change in configuration of the container reinforces locking with the lid.

8. The eggcup according to claim 1, wherein at least one container clip comprises a horizontal part attached to the container at a minimum number of three regularly distributed points and the length of a complementary part is substantially equal to the distance between two of the points, such that, when the eggcup is in a closed condition, the horizontal and complementary parts are in a fixed position, and the height of the complementary part is less than the height of the points.

9. The eggcup according to claim 8, wherein the fastening parts are distributed in an equiangular fashion on the container and the lid.

10. An eggcup comprising:
a container forming an interior container space sized and shaped to receive a portion of an egg, the container having an opening formed by a container rim located along the circumference of the container;
a lid forming an interior lid space sized and shaped to receive a remaining portion of the egg, the lid having an opening formed by a lid rim located along the circumference of the lid;
a container fastener extending outwardly from the container rim for a distance sufficient to engage the lid rim when the lid is in a closed position; and
a lid fastener extending inwardly from the lid rim for a distance sufficient to engage the container rim when the lid is in a closed position;
wherein the lid fastener has an engaging surface shaped and sized to engage a complementary engaging surface of the container fastener when the lid is in a closed position; and
wherein the container and lid rims are formed such that, when the lid is in a closed position and substantially at room temperature, an expansion space is located adjacent the container and lid fasteners and, upon heating of the egg, heat transfers to the container such that the container softens at the container rim and expands into the expansion space, thereby providing secondary locking action.
